(19) United States
(12) Patent Application Publication
(10) Pub. No.: US 2013/0115494 A1
(43) Pub. Date: May 9, 2013

(54) RECHARGEABLE BATTERY

(71) Applicant: Duk-Jung KIM, Yongin-si (KR)

(72) Inventor: Duk-Jung KIM, Yongin-si (KR)

(21) Appl. No.: 13/606,319

(22) Filed: Sep. 7, 2012

(30) Foreign Application Priority Data
Nov. 3, 2011 (KR) 10-2011-0114029

(51) Int. Cl. H01M 2/02; H01M 2/04; H01M 2/30; H01M 10/50

(52) U.S. Cl. 429/94; 429/179; 429/120

(57) ABSTRACT

A rechargeable battery including at least one electrode assembly, the at least one electrode assembly including a positive electrode and a negative electrode; a case accommodating the electrode assembly, the case having an installation surface; a terminal installed on the installation surface of the case; and a cap member coupled with the case.

### BACKGROUND

1. Field

Embodiments relate to a rechargeable battery.

2. Description of the Related Art

A rechargeable battery may be repeatedly charged and discharged, unlike a primary battery, which may not be recharged. A small-capacity rechargeable battery may be used in a portable compact electronic device, e.g., a mobile phone, a laptop computer, and a camcorder, and a large-capacity battery may be used as a motor driving power supply of a hybrid vehicle.

A high power rechargeable battery using a non-aqueous electrolyte having high energy density has been developed. The high power rechargeable batteries may be connected with each other in series or in parallel to prepare a high power and large capacity battery module.

A battery module may include a plurality of rechargeable batteries that are generally connected to each other in series, and the rechargeable battery may have, e.g., a cylindrical shape, a hexahedral shape, or the like.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery.

The embodiments may be realized by providing a rechargeable battery including at least one electrode assembly, the at least one electrode assembly including a positive electrode and a negative electrode; a case accommodating the electrode assembly, the case having an installation surface; a terminal installed on the installation surface of the case; and a cap member coupled with the case.

The case may have an opening therein, the opening being closed by the cap member in an assembled condition of the rechargeable battery.

The opening in the case may face the installation surface.

The cap member may have a plate shape, and a thickness of the cap member may be smaller than a thickness of the case.

The cap member may include an electrode support thereon, the electrode support protruding toward the electrode assembly and supporting the electrode assembly.

The electrode support may include a groove, a lower end of the electrode assembly being accommodated in the groove.

The cap member may include a cooling protrusion on an outer surface thereof

The cap member may form a lower surface of the case, the lower surface of the case being opposite to the installation surface that includes the terminal thereon.

The opening may be on a side of the case perpendicular to the installation surface.

The opening may include a first opening and a second opening, and the first opening and the second opening may face each other at sides of the case.

The cap member may be welded to the case at the opening.

The electrode assembly may be wound about a reference axis, and the electrode assembly may be accommodated in the case such that the reference axis is perpendicular to a plane of the cap member.

The electrode assembly may be accommodated in the case such that the reference axis is perpendicular to an opening in the case, the opening being closed by the cap member in an assembled condition of the rechargeable battery.

The case may include a first opening and a second opening, the first opening and the second opening each being perpendicular to the installation surface, and a third opening facing the installation surface, the first opening and the second opening being at sides of the third opening and facing each other.

The cap member may include a bottom plate coupled with the third opening, a first side plate bent at one side end of the bottom plate, the first side plate being coupled with the first opening, and a second side plate bent at another side end of the bottom plate, the second side plate being coupled with the second opening.

The rechargeable battery may include a plurality of electrode assemblies in the case.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view showing a rechargeable battery according to an embodiment.

FIG. 2 illustrates a cross-sectional view taken along line II-II of FIG. 1.

FIG. 3 illustrates a horizontal cross-sectional view showing a part of the rechargeable battery of FIG. 1.

FIG. 4 illustrates an exploded perspective view showing a case and a cap member of the rechargeable battery of FIG. 1.

FIG. 5 illustrates a bottom partial perspective view of a rechargeable battery according to another embodiment.

FIG. 6 illustrates a perspective view showing a cap member of the rechargeable battery of FIG. 5.

FIG. 7 illustrates a perspective view showing a rechargeable battery according to yet another embodiment.

FIG. 8 illustrates an exploded perspective view of the rechargeable battery of FIG. 7.

FIG. 9 illustrates an exploded perspective view showing a case and a cap member of a rechargeable battery according to still another embodiment.

### DETAILED DESCRIPTION

Korean Patent Application No. 10-2011-0114029, filed on Nov. 3, 2011, in the Korean Intellectual Property Office, and entitled: “Rechargeable Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

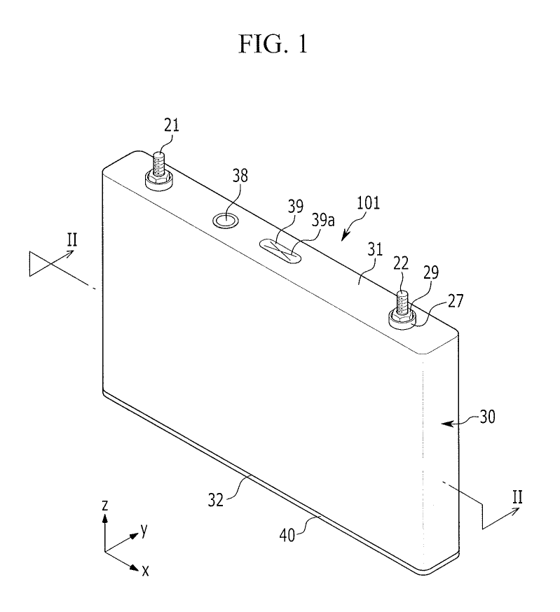

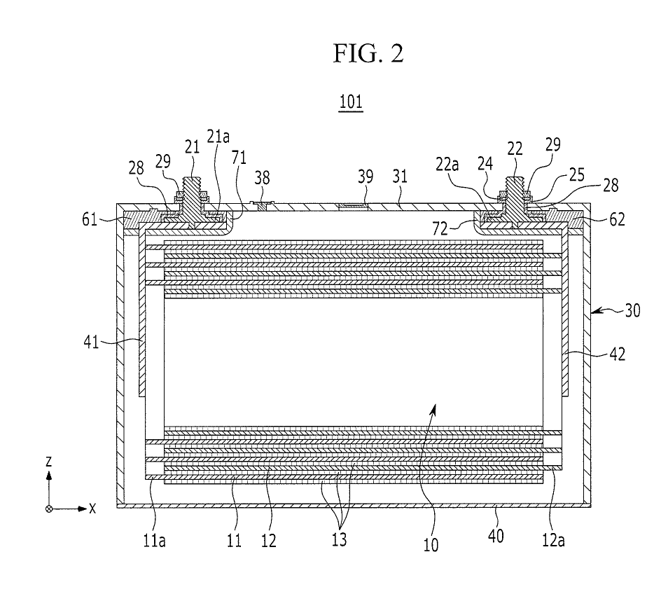

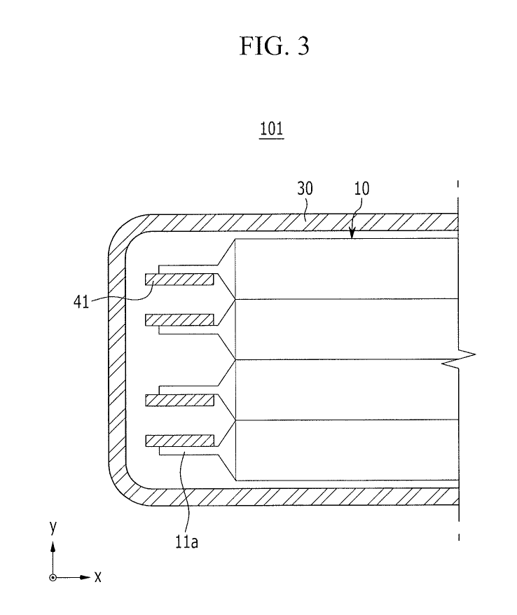

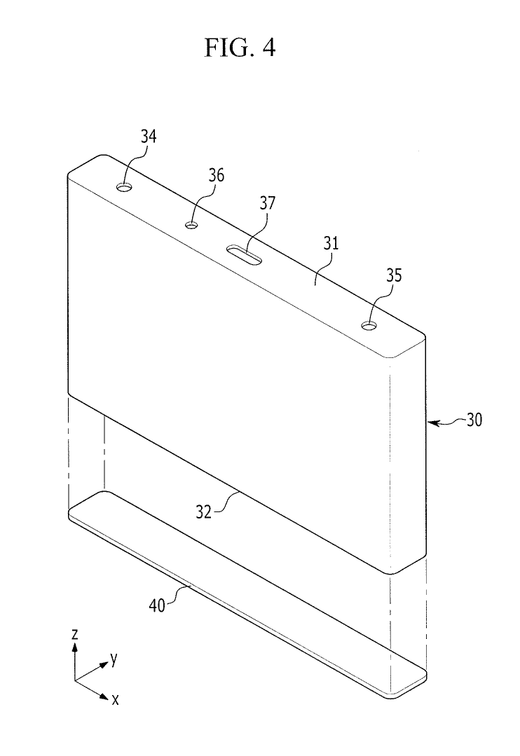

FIG. 1 illustrates a perspective view showing a rechargeable battery according to an embodiment. FIG. 2 illustrates a cross-sectional view taken along line II-II of FIG. 1. FIG. 3 illustrates a horizontal cross-sectional view showing a part of the rechargeable battery of FIG. 1. FIG. 4 illustrates an exploded perspective view showing a case and a cap member of the rechargeable battery of FIG. 1.

Referring to FIGS. 1 and 2, a rechargeable battery 101 according to the present embodiment may include an electrode assembly 10 (wound by interposing a separator 13 between a positive electrode (first electrode) 11 and a negative electrode (second electrode) 12), a case 30 housing or accommodating the electrode assembly 10, and a cap member 40 coupled with an opening of the case 30.

In an implementation, rechargeable battery 101 may have a hexahedral or prismatic shape and may be a lithium ion secondary battery. However, the embodiments are not limited thereto, and may be applied to various types of batteries, e.g., a lithium polymer battery, a cylindrical battery, or the like.

The positive electrode 11 and the negative electrode 12 may include a coating region (in which an active material is coated on a current collector formed of a thin-film metal foil) and an uncoated region (in which the active material is not coated).

A positive electrode uncoated region 11a may be formed at one side end of the positive electrode 11 along a length direction of the positive electrode 11. A negative electrode uncoated region 12a may be formed at another side end of the negative electrode 12 along a length direction of the negative electrode 12. In addition, the positive electrode 11 and the negative electrode 12 may be wound with the separator 13 (as an insulator) interposed therebetween.

However, the embodiments are not limited thereto, and the electrode assembly 10 may be formed in a structure in which a positive electrode and a negative electrode formed of a plurality of sheets are stacked with the separator interposed therebetween.

The case 30 may have a substantially cuboid or hexahedral shape, and an opened opening 32 may be disposed at one surface thereof. As shown in FIG. 4, a first terminal hole 34 (through which a positive electrode terminal 21 may be inserted) and a second terminal hole 35 (through which a negative electrode terminal 22 may be inserted) may be formed on an installation surface 31 of the case 30. In an implementation, the installation surface 31 may face, e.g., may be opposite to, the opening 32. An electrolyte injection opening 36 (for injecting an electrolyte) and a vent hole 37 (for installing a vent member 39) may be formed in the installation surface 31. The installation surface 31 may serve as an upper surface of the case 30 when the case 30 is arranged with the positive terminal 21 facing up.

The positive electrode terminal 21 may be inserted through and coupled with the first terminal hole 34 to protrude outside of the case 30. A first gasket 25 (disposed above) and a second gasket 28 (disposed below) may be installed between the installation surface 31 and the positive electrode terminal 21 to insulate the installation surface 31 and the positive electrode terminal 21. A nut 29 may be coupled with the positive electrode terminal 21, and a washer 24 may be installed between the nut 29 and the first gasket 25.

A terminal flange 21a may be formed at a lower end of the positive electrode terminal 21, and the second gasket 28 may inserted into the first terminal hole 34 to cover the terminal flange 21a. A lower cover 71 (covering an upper end of a current collecting member 41 and the terminal flange 21a) may be installed below the second gasket 28, and a lower insulation member 61 (partially covering the second gasket 28) may be coupled with an upper portion of the lower cover 71.

The negative electrode terminal 22 may be inserted through and coupled with the second terminal hole 35 to protrude outside of the case 30. The first gasket 25 (disposed above) and the second gasket 28 (disposed below) may be installed between the installation surface 31 and the negative electrode terminal 22 to insulate the installation surface 31 and the negative electrode terminal 22. The nut 29 may be coupled with the negative electrode terminal 22, and the washer 24 may be installed between the nut 29 and the first gasket 25.

A terminal flange 22a may be formed at a lower end of the negative electrode terminal 22, and the second gasket 28 may cover the terminal flange 22a. A lower insulation member 62 may be installed between the second gasket 28 and the installation surface 31, and a lower cover 72 (covering an upper end of a current collecting member 42 and the terminal flange 22a) may be installed below the lower insulation member 62.

As shown in FIG. 3, in an implementation, four electrode assemblies 10 may be inserted into the case 30. Accordingly, the current collecting members 41 and 42 may have four tabs respectively bonded with the electrode assemblies 10.

The cap member 40 (for sealing the opening 32) may be installed at or coupled with the opening 32 facing the installation surface 31. The cap member 40 may be fixed to the opening 32 of the case 30 by, e.g., welding, and may have a thickness smaller than a thickness of the case 30.

The cap member 40 may be disposed at a lower surface or lower end of the case 30 when the case 30 is arranged with the positive terminal 21 facing up. The cap member 40 may have flatness flatter than a flatness of the case 30. Accordingly, the case 30 may be stably installed in a housing, such that it is possible to prevent the rechargeable battery 101 from being shaken due to external impact or vibration.

Further, the terminals 21 and 22 may be installed on the installation surface 31 of the case 30, rather than the cap member 40, to thereby be relatively and stably fixed. The cap member 40 may be attached and fixed to the case 30 and an unstable surface may exist. However, four sides of the installation surface 31 may be supported by an external circumferential surface to stably support the terminals 21 and 22.

Further, the terminals 21 and 22 may be installed on the installation surface 31, such that deformation of the gaskets 25 and 28 and the like by heat in a process of welding the cap member 40 may be avoided, thereby helping to prevent a deterioration of sealing performance. Thus, leaking of the electrolyte and short-circuits may be reduced and/or prevented, and safety of the rechargeable battery may be improved.

Further, the thickness of the cap member 40 may be smaller than the thickness of the case 30, such that heat may be more efficiently discharged through the cap member 40.

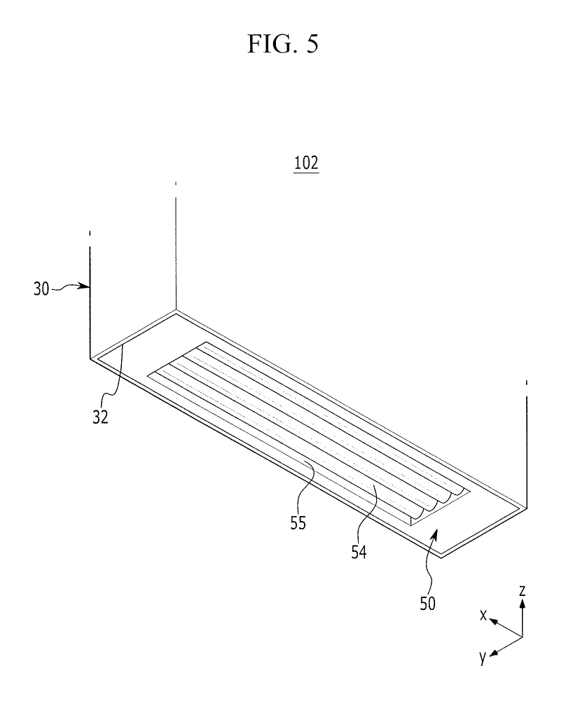

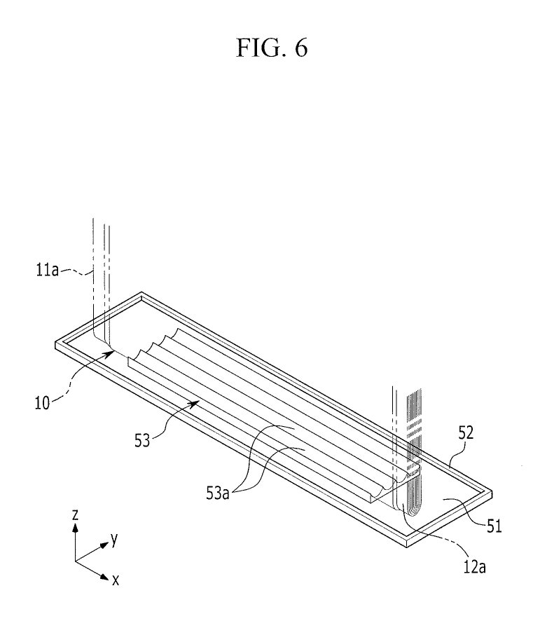

FIG. 5 illustrates a partial bottom perspective view of a rechargeable battery according to another embodiment. FIG. 6 illustrates a perspective view of a cap member of the rechargeable battery of FIG. 5.

Referring to FIGS. 5 and 6, a rechargeable battery 102 according to the present embodiment may have the same structure as the rechargeable battery according to the previous embodiment, except for a structure of a cap member 50. Accordingly, repeated descriptions for the same elements may be omitted.

The cap member 50 according to the present embodiment may include a plate part 51 and a support protrusion 52 protruding from a side end of the plate part 51. The plate part 51 may have a substantially rectangular plate shape, and the support protrusion 52 may protrude along the side end of the plate part 51 to be inserted into the opening of the case. As described above, when the support protrusion 52 is formed at the side end of the plate part 51, although the thickness of the cap member 50 may be small, a shape of the cap member 50 may be stably maintained.

An electrode support part 53 (supporting the electrode assembly 10) may be formed on the cap member 50 to protrude toward the electrode assembly 10. An arc-shaped groove 53a may be formed at the electrode support part 53 so as to support a lower end of the electrode assembly 10. The groove 53a may extend along a length direction of the electrode assembly 10, and the groove 53a may not contact the uncoated region by providing support only at a central region of the electrode assembly 10.

In an implementation, the rechargeable battery may include four electrode assemblies 10. Thus, four corresponding grooves 53a may be formed in the electrode support part 53.

The cap member 50 may be bent or stamped to form the electrode support part 53 and, accordingly, a groove 55 may be formed at an outer surface of the cap member 50. A cooling protrusion 54 protruding downwards may be formed at the groove 55. The cooling protrusion 54 may have an arc shape, and a surface area of the cap member 50 may be increased due to the cooling protrusion 54.

When the electrode support part 53 (contacting and supporting the lower end of the electrode assembly 10) is formed on the cap member 50, components of the rechargeable battery 102 may be stably prevented from being shaken due to the impact or vibration.

Further, the cap member 50 may be thinner than the case 30, and the cooling protrusion 54 may be formed at the cap member 50. Thus, heat in the case 30 may be rapidly discharged outside of the rechargeable battery 102 through the cap member 50.

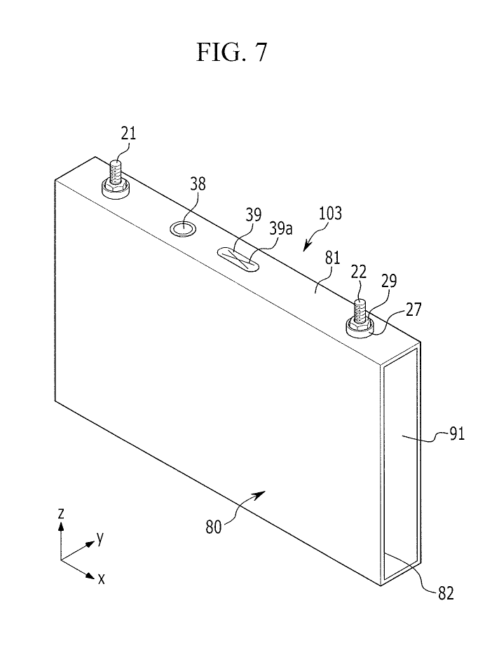

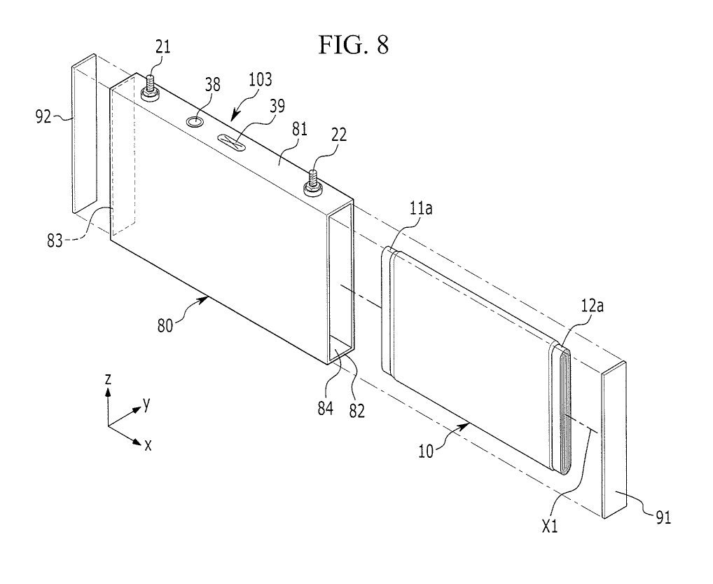

FIG. 7 illustrates a perspective view showing a rechargeable battery according to yet another embodiment. FIG. 8 illustrates an exploded perspective view showing the rechargeable battery of FIG. 7.

Referring to FIGS. 7 and 8, a rechargeable battery 103 according to the present embodiment has the same structure as the rechargeable battery according to the previous embodiments, except for a structure of a case 80 and cap members 91 and 92. Accordingly, repeated descriptions of like elements may be omitted.

The rechargeable battery 103 according to the present embodiment may include a case 80, an electrode assembly 10 accommodated in the case 80, and cap members 91 and 92 sealing or coupled with openings 82 and 83 in the case 80.

The case 80 may include an installation surface 81 (where the positive electrode terminal 21 and the negative electrode terminal 22 are installed), a bottom 84 (facing or opposite to the installation surface 81), and a first opening 82 and a second opening 83 at a surface crossing the installation surface 81, e.g., at respective sides of or perpendicular to the installation surface 81.

The first opening 82 and the second opening 83 may be formed at sides that face or are opposite to each other. The first opening 82 and the second opening 83 may extend to the installation surface 81 from the bottom 84, e.g., may extend from the bottom 84 to the installation surface 81. For example, the case may have a tube-like structure, in which sides facing each other, e.g., opposing side, are open.

The electrode assembly 10 may be wound about a reference axis X1 to form a jelly-roll structure. The reference axis X1 may cross the openings 82 and 83 in the case 80. For example, the reference axis X1 may be perpendicular to a plane of the openings 82 and 83 in the case 80. Accordingly, a side (e.g., a wound cross-section of the electrode assembly 10) may be parallel with the plane of the openings 82 and 83 of the case 80.

When the cap members 91 and 92 are disposed at the sides of the case 80, other members may be prevented from being damaged due to heat during welding of the cap members 91 and 92 to the case 80. For example, the heat may be easily discharged through the cap members 91 and 92.

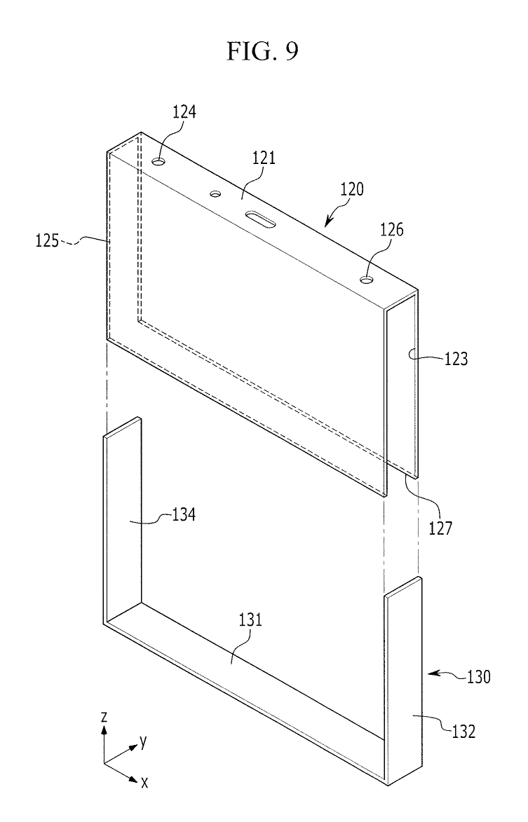

FIG. 9 illustrates an exploded perspective view showing a case and a cap member of a rechargeable battery according to still another embodiment.

Referring to FIG. 9, the rechargeable battery according to the present embodiment has the same structure as the rechargeable battery according to the previous embodiments, except for a structure of a case 120 and a cap member 130. Accordingly, repeated descriptions of like elements may be omitted.

The case 120 according to the present embodiment may include an installation surface 121 (on which a positive electrode terminal (not illustrated) and a negative electrode terminal (not illustrated) are installed), a first opening 123 and a second opening 125 at a surface crossing, e.g., at sides perpendicular to, the installation surface 121, and a third opening 127 facing or opposite to the installation surface 121.

The first opening 123 and the second opening 125 may be formed at sides of the case 120 that face or are opposite each other. The third opening 127 may connect the first opening 123 and the second opening 125, e.g., may extend between the first opening 123 and the second opening 125. The third opening 127 may be formed at a bottom of the case 120 when the case 30 is disposed with the positive terminal facing up. The first opening 123 and the second opening 125 may extend toward the installation surface 121 from the third opening 127, e.g., may extend between the third opening 127 and the installation surface 121.

The cap member 130 may include a bottom plate 131 (coupled with the third opening 127), a first side plate 132 (bent at one side end of the bottom plate 131), and a second side plate 134 (bent at another side end of the bottom plate 131). The bottom plate 131 may connect a lower end of the first side plate 132 and a lower end of the second side plate 134, e.g., may extend between the lower end of the first side plate 132 and the lower end of the second side plate 134. The first side plate 132 may be coupled with the first opening 123, and the second side plate 134 may be coupled with the second opening 125.

The case 120 according to the present embodiment may have a structure that is open on three sides thereof The cap member 130 may seal the three open sides, thereby easily forming a rechargeable battery that includes the case 120 and the cap member 130. For example, the case 120 may be formed of three connected plates. Thus, the case 120 may be formed by bending the plates. The cap member 130 may also be formed of three connected plates. Thus, the cap member 130 may also be formed by bending the plates.

By way of summation and review, a rechargeable battery may include a case and a cap plate welded to the case. Components installed on the cap plate may be damaged by heat provided while welding the cap plate to the case. For example, a gasket may be deformed due to the heat transferred to the cap plate in the welding process. When the gasket is deformed, sealing performance may be deteriorated such that the electrolyte may leak out of the battery.

In addition, a bottom of the case should be flat. Thus, when external vibration or impact is applied, and the case is seriously shaken, an electrical connection between the components of the rechargeable battery may be maintained.

For example, in the case of the rechargeable battery installed in an electric vehicle, vibration or impact may be constantly transferred to the rechargeable battery due to traveling of the vehicle. Thus, it is desirable to stably fix and install the case.

The embodiments provide a rechargeable battery having improved safety.

According to an embodiment, terminals may be fixed to an installation surface and a cap member may be fixed and coupled with an opening formed at another surface, such that it is possible to prevent other components from being damaged due to heat applied while welding the cap member to the case. The embodiments provide a rechargeable battery having an improved case structure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
at least one electrode assembly, the at least one electrode assembly including a positive electrode and a negative electrode;
a case accommodating the electrode assembly, the case having an installation surface;
a terminal installed on the installation surface of the case; and
a cap member coupled with the case.

2. The rechargeable battery as claimed in claim 1, wherein the case has an opening therein, the opening being closed by the cap member in an assembled condition of the rechargeable battery.

3. The rechargeable battery as claimed in claim 2, wherein the opening in the case faces the installation surface.

4. The rechargeable battery as claimed in claim 3, wherein:
the cap member has a plate shape, and
a thickness of the cap member is smaller than a thickness of the case.

5. The rechargeable battery as claimed in claim 3, wherein the cap member includes an electrode support thereon, the electrode support protruding toward the electrode assembly and supporting the electrode assembly.

6. The rechargeable battery as claimed in claim 5, wherein the electrode support includes a groove, a lower end of the electrode assembly being accommodated in the groove.

7. The rechargeable battery as claimed in claim 3, wherein the cap member includes a cooling protrusion on an outer surface thereof.

8. The rechargeable battery as claimed in claim 3, wherein the cap member forms a lower surface of the case, the lower surface of the case being opposite to the installation surface that includes the terminal thereon.

9. The rechargeable battery as claimed in claim 2, wherein the opening is on a side of the case perpendicular to the installation surface.

10. The rechargeable battery as claimed in claim 9, wherein:
the opening includes a first opening and a second opening, and
the first opening and the second opening face each other at sides of the case.

11. The rechargeable battery as claimed in claim 2, wherein the cap member is welded to the case at the opening.

12. The rechargeable battery as claimed in claim 1, wherein:
the electrode assembly is wound about a reference axis, and
the electrode assembly is accommodated in the case such that the reference axis is perpendicular to a plane of the cap member.

13. The rechargeable battery as claimed in claim 12, wherein the electrode assembly is accommodated in the case such that the reference axis is perpendicular to an opening in the case, the opening being closed by the cap member in an assembled condition of the rechargeable battery.

14. The rechargeable battery as claimed in claim 1, wherein the case includes:
a first opening and a second opening, the first opening and the second opening each being perpendicular to the installation surface, and
a third opening facing the installation surface, the first opening and the second opening being at sides of the third opening and facing each other.

15. The rechargeable battery as claimed in claim 14, wherein the cap member includes:
a bottom plate coupled with the third opening,
a first side plate bent at one side end of the bottom plate, the first side plate being coupled with the first opening, and
a second side plate bent at another side end of the bottom plate, the second side plate being coupled with the second opening.

16. The rechargeable battery as claimed in claim 1, wherein the rechargeable battery includes a plurality of electrode assemblies in the case.
